(19) United States
(12) Patent Application Publication
(10) Pub. No.: US 2024/0345781 A1
(43) Pub. Date: Oct. 17, 2024

(54) INSPECTION SYSTEM

(71) Applicant: CANON KABUSHIKI KAISHA, Tokyo (JP)

(72) Inventor: TAKESHI KINOSHITA, Chiba (JP)

(21) Appl. No.: 18/635,800

(22) Filed: Apr. 15, 2024

(30) Foreign Application Priority Data
Apr. 17, 2023 (JP) 2023-067375
Mar. 28, 2024 (JP) 2024-054633

(51) Int. Cl. G06F 3/12; G06T 7/00; G06T 7/11

(52) U.S. Cl. CPC G06F 3/1208; G06F 3/1256; G06T 7/001; G06T 7/11; G06T 2207/10008; G06T 2207/20104; G06T 2207/30144

(57) ABSTRACT

An inspection system includes an image-forming unit configured to form an image on a sheet, a reading unit configured to read the image formed on the sheet, and a controller. The controller obtains reference image data for image inspection, executes the image inspection on a result of reading the image based on the obtained reference image data, and controls a display to display a preview screen related to the image inspection. In a case where the image includes a mark indicating a trimming position of the sheet, the preview screen includes a main image that includes the mark, and an additional image that is added to the main image and indicates a second region outward of a first region corresponding to the sheet subjected to trimming.

### BACKGROUND

### Field of the Disclosure

The present disclosure relates to an inspection system for inspecting an image on a sheet.

### Description of the Related Art

Conventionally, there are known inspection systems for inspecting an image formed on a sheet by a printer, by reading the image using a scanner disposed downstream of the printer and analyzing the read image. The colors of a read image of three color components (for example, red (R), green (G), and blue (B)) in the bitmap format may be inspected by comparing the image with a corresponding reference image, for example. A sheet for which a fault has been detected as a result of inspection may be discharged to a discharge destination of faulty sheets, in order to distinguish the faulty sheet from normal sheets.

Japanese Patent Laid-Open No. 2021-187071, for example, discloses a technique in which only an area designated by the user via a user interface, out of an inspection target image, is set as an inspection target. Japanese Patent Laid-Open No. 2021-187071 also states that, if the designated inspection target area includes margin regions of a document or a tone patch region for proofreading, the user is prompted to change the designated inspection target area, and such regions may be removed through trimming in post-processing.

However, it is not easy for the user to accurately designate, via a UI, an area to be inspected or an area to be excluded from inspection. When a portion of a sheet is trimmed in post-processing, for example, a portion that is removed through trimming does not affect whether or not a final deliverable product is acceptable. For this reason, if an area to be excluded is not accurately designated, the yield of deliverable product decreases and the usability decreases, for example, a case arises where a sheet is determined as being unacceptable although there is no problem as a deliverable product.

### SUMMARY

In view of the aforementioned circumstances, the present disclosure is for improving the usability related to inspection of an image on a sheet.

According to an aspect, there is provided an inspection system including: an image-forming unit configured to form an image on a sheet; a reading unit configured to read the image formed on the sheet; and a controller configured to: obtain reference image data for image inspection, execute the image inspection on a result of reading the image by the reading unit, based on the obtained reference image data, and control a display to display a preview screen related to the image inspection. In a case where the image includes a mark indicating a trimming position of the sheet, the preview screen includes: a main image that includes the mark, and an additional image that is added to the main image and indicates a second region outward of a first region corresponding to the sheet subjected to trimming.

Further features of the present disclosure will become apparent from the following description of exemplary embodiments (with reference to the attached drawings).

### BRIEF DESCRIPTION OF THE DRAWINGS

FIG. 1A is a schematic diagram showing a first portion of a configuration of an inspection system according to an embodiment of the present disclosure.

FIG. 1B is a schematic diagram showing a second portion of the configuration of the inspection system according to one or more aspects of the present disclosure.

FIG. 2 is a block diagram showing an example of detailed configurations of an operation unit and a control apparatus.

FIG. 3 is a block diagram showing an example of a detailed configuration of an inspection controller.

FIG. 4 is an explanatory diagram showing an example of a configuration of a print setting screen according to one or more aspects of the present disclosure.

FIG. 5A is an explanatory diagram showing a first example of a configuration of an inspection setting screen according to one or more aspects of the present disclosure.

FIG. 5B is an explanatory diagram showing a second example of the configuration of the inspection setting screen according to one or more aspects of the present disclosure.

FIG. 5C is an explanatory diagram showing a third example of the configuration of the inspection setting screen according to one or more aspects of the present disclosure.

FIG. 6 is a flowchart showing an example of flow of job execution processing according to one or more aspects of the present disclosure.

FIG. 7 is a flowchart showing an example of detailed flow of inspection setting processing according to one or more aspects of the present disclosure.

FIG. 8 is an explanatory diagram showing an example of a confirmation message that may be displayed according to one or more aspects of the present disclosure.

FIG. 9 is a flowchart showing an example of detailed flow of inspection setting processing according to one or more aspects of the present disclosure.

FIG. 10 is an explanatory diagram showing an example of a confirmation message that may be displayed according to one or more aspects of the present disclosure.

FIG. 11 is an explanatory diagram showing an example of a configuration of an inspection setting screen according to one or more aspects of the present disclosure.

FIG. 12 is a flowchart showing an example of detailed flow of inspection setting processing according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### 1. Overview of System

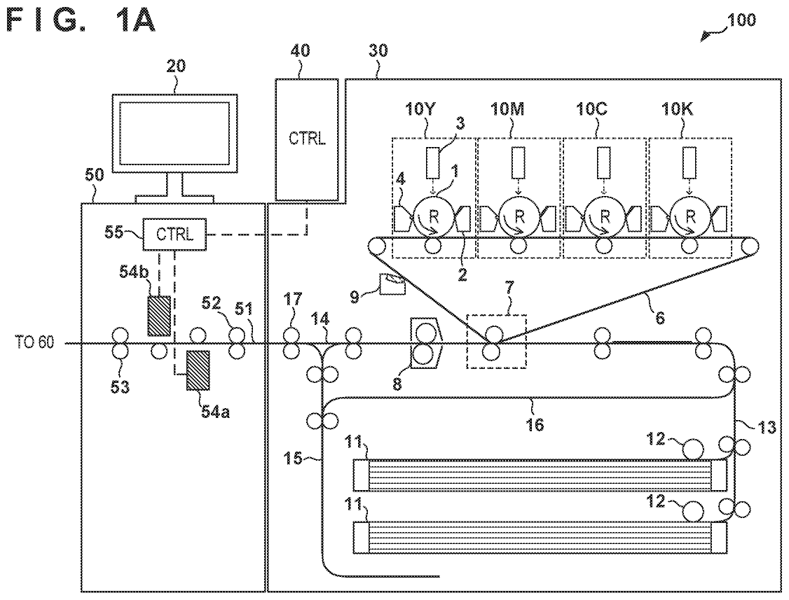

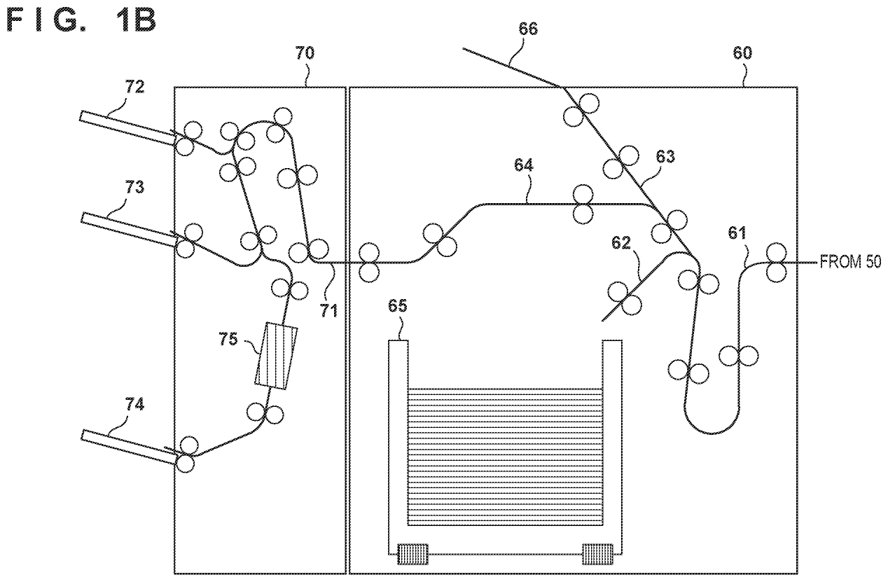

FIGS. 1A and 1B are schematic diagrams showing a configuration of an inspection system 100 according to an embodiment of the present disclosure. Referring to FIG. 1A, the inspection system 100 includes an operation unit 20, an image-forming apparatus 30, a control apparatus 40, and an inspection apparatus 50. Referring to FIG. 1B, the inspection system 100 further includes a stacker 60 and a finisher 70.

### (1) Operation Unit

The operation unit 20 includes an input device and an output device, and provides a user interface (UI) to the user. The operation unit 20 accepts user input via the input device, and transmits an input signal corresponding to the accepted user input to the control apparatus 40. In addition, the operation unit 20 outputs information from the output device based on an output signal received from the control apparatus 40 (for example, causes a display to display an image, or causes a speaker to output sound).

### (2) Image-Forming Apparatus

The image-forming apparatus 30 is an apparatus for forming an image on a sheet (also referred to as a “printer”). In the present embodiment, the image-forming apparatus 30 is a color printer capable of forming a color image. In other embodiments, the image-forming apparatus 30 may be a monochrome printer. The image-forming apparatus 30 includes image-forming units 10Y, 10M, 10C, and 10K, the intermediate transfer member 6, a transfer unit 7, a fixing device 8, a cleaner 9, two paper feeding cassettes 11, and a feeding mechanism.

The image-forming unit 10Y forms a yellow (Y) toner image on the intermediate transfer member 6. The image-forming unit 10M forms a magenta (M) toner image on the intermediate transfer member 6. The image-forming unit 10C forms a cyan (C) toner image on the intermediate transfer member 6. The image-forming unit 10K forms a black (K) toner image on the intermediate transfer member 6. The image-forming units 10Y, 10M, 10C, and 10K have the same configuration, and thus, here, the configuration of the image-forming unit 10Y will be described as an example. The image-forming unit 10Y includes a photosensitive drum 1, a charging device 2, an exposing device 3, and a developing device 4. The photosensitive drum 1 is a drum-like photosensitive member having a photosensitive layer on the surface thereof. The photosensitive drum 1 rotates in the direction of the arrow R in the figure about a drum axis. The charging device 2 uniformly charges the surface of the rotating photosensitive drum 1. The exposing device 3 irradiates the photosensitive drum 1 with laser light in accordance with image data (here, a yellow image) input from the control apparatus 40. Laser light output from the exposing device 3 scans the charged surface of the photosensitive drum 1 in the drum axis direction, and thereby an electrostatic latent image is formed on the surface of the photosensitive drum 1. The developing device 4 develops the electrostatic latent image on the photosensitive drum 1 by supplying (here, yellow) toner to the surface of the photosensitive drum 1. As a result, a toner image is formed on the surface of the photosensitive drum 1. The yellow toner image formed on the surface of the photosensitive drum 1 of the image-forming unit 10Y is transferred to the intermediate transfer member 6. Furthermore, magenta, cyan, and black toner images formed on the surfaces of the photosensitive drums of the respective image-forming units 10M, 10C, and 10K are transferred to the intermediate transfer member 6 such that the magenta, cyan, and black toner images are superimposed on the yellow toner image. Accordingly, a full-color toner image is formed on the intermediate transfer member 6. The intermediate transfer member 6 is an endless belt member, and rotates in the clockwise direction in the figure. The intermediate transfer member 6 conveys the full-color toner image to the position of the transfer unit 7 (transfer position).

Each paper feeding cassette 11 accommodates a bundle of sheets. A sheet is picked up from one of the paper feeding cassettes 11 using a pickup roller 12, and is conveyed along a conveyance path 13. Under control of the control apparatus 40, the sheet is conveyed to the transfer position in accordance with a timing when the toner image on the intermediate transfer member 6 reaches the transfer position.

The transfer unit 7 transfers the toner image supported by the intermediate transfer member 6 onto the sheet at the transfer position. The fixing device 8 includes a heater and a pressing roller. The fixing device 8 heats the toner image transferred onto the sheet, using the heater, and pressurizes the sheet using the pressing roller. Accordingly, the toner on the sheet melts, and the toner image is fixed to the sheet. The cleaner 9 is disposed downstream of the transfer position on the path of the intermediate transfer member 6, and removes toner that remains on the intermediate transfer member 6 after the toner image has been transferred.

Downstream of the fixing device 8, the conveyance path 13 branches into conveyance paths 14 and 15. A sheet that has passed through the fixing device 8 is temporarily conveyed from the conveyance path 13 to the conveyance path 15. When the trailing edge of the sheet enters the conveyance path 15, the conveyance direction is reversed, and the sheet is discharged from discharge rollers 17 to the inspection apparatus 50. Through such conveyance, the sheet is discharged in a state where the side on which an image is formed is directed downward (which is called “face down”). Note that, when two-sided printing is performed, a sheet that has entered the conveyance path 15 is conveyed to a conveyance path 16, returns from the conveyance path 16 to the conveyance path 13, and passes through the transfer position again in a state where the two sides of the sheet are reversed. A toner image is formed on the back side of the sheet by the transfer unit 7 at the transfer position, and the toner image is fixed to the sheet by the fixing device 8. The sheet with images printed on the two sides thereof is discharged from the discharge rollers 17 to the inspection apparatus 50.

### (3) Control Apparatus

The control apparatus 40 interacts with the user via the operation unit 20 or a below-described host computer 90, and controls operations of the image-forming apparatus 30, the inspection apparatus 50, the stacker 60, and the finisher 70. The control apparatus 40 may be a portion of the image-forming apparatus 30 or the inspection apparatus 50. When the user requests that a print job be executed, for example, the control apparatus 40 controls the image-forming apparatus 30 to form an image that is based on designated input image data, on a sheet. A configuration of the control apparatus 40 will be described below further in detail.

### (4) Inspection Apparatus

The inspection apparatus 50 is disposed downstream of the image-forming apparatus 30. The inspection apparatus 50 includes a conveyance path 51, conveyance rollers 52 and 53, a first reading unit 54a, a second reading unit 54b, and an inspection controller 55. The conveyance rollers 52 accept a sheet discharged from the image-forming apparatus 30, and conveys the sheet along the conveyance path 51. The first reading unit 54a optically reads an image formed on the lower side of the sheet passing through a reading position of the first reading unit 54a, generates read image data, and outputs the generated read image data to the inspection controller 55. The first reading unit 54a includes one or more white light emitting diodes (LEDs) for irradiating a sheet with white light, and a pixel array of an image sensor for detecting reflected light reflected by the lower surface of the sheet, for example. Here, the image sensor may be a contact image sensor (CIS) or a line scan camera, for example. Typically, image sensors separate reflected light from a sheet into three color components using RGB color filters, and receive light. For this reason, read image data output from the first reading unit 54a is raster data indicating, for the respective pixels, three-dimensional vectors that each have three RGB color component values. The second reading unit 54b optically reads an image formed on the upper side of the sheet passing through the reading position of the second reading unit 54b, generates read image data, and outputs the generated read image data to the inspection controller 55. The second reading unit 54b may be configured similarly to the first reading unit 54a, and the read image data output from the second reading unit 54b is also raster data indicating, for the respective pixels, three-dimensional vectors that each have three RGB color component values. That is to say, the inspection apparatus 50 can read the image on the sheet while conveying the sheet. The conveyance rollers 53 discharge, to the stacker 60, the sheet that has passed through the reading positions of the first reading unit 54aand the second reading unit 54b. The inspection controller 55 controls these operations of the inspection apparatus 50 in cooperation with the control apparatus 40, and inspects the image formed on the sheet. The configuration of the inspection controller 55 will be described below further in detail.

### (5) Stacker

The stacker 60 is a loading device disposed downstream of the inspection apparatus 50. Referring to FIG. 1B, the stacker 60 includes conveyance paths 61, 62, 63, and 64, a large capacity tray 65, and a purge tray 66. The stacker 60 accepts a sheet provided from the inspection apparatus 50, and passes the accepted sheet to the conveyance path 61. The conveyance path 61 branches into the conveyance path 62 to the large capacity tray 65, the conveyance path 63 to the purge tray 66, and the conveyance path 64 to the finisher 70. A sheet for which a fault has been detected as a result of inspection performed by the inspection apparatus 50 may be discharged to the purge tray 66 through the conveyance path 63, under control of the control apparatus 40, for example. In addition, a sheet that requires post-processing by the finisher 70 may be discharged to the finisher 70, and sheets other than that may be discharged to the large capacity tray 65.

### (6) Finisher

The finisher 70 is a post-processing apparatus disposed downstream of the stacker 60. Referring to FIG. 1B, the finisher 70 includes a conveyance path 71, discharge trays 72, 73, and 74, and a post-processing unit 75. The finisher 70 accepts a sheet provided from the stacker 60, passes the accepted sheet to the conveyance path 71, and discharges the sheet to one of the discharge trays 72, 73, and 74. The post-processing unit 75 is provided on the conveyance path to the discharge tray 74, and performs post-processing on one or more sheets. The post-processing unit 75 has a mechanism for performing one or more of binding processing for binding a sheet bundle using a stapler, bookbinding processing for folding the sheet in half into a book, and trimming processing for trimming the sheet bundle, for example. The post-processing unit 75 performs designated post-processing under control of the control apparatus 40.

### 2. Configuration Example of Control Apparatus

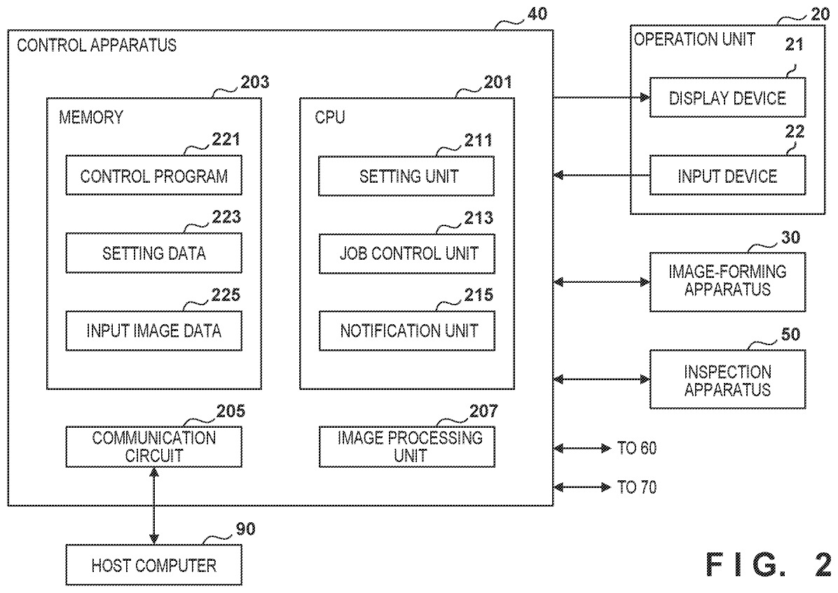

FIG. 2 is a block diagram showing an example of detailed configurations of the operation unit 20 and the control apparatus 40. Referring to FIG. 2, the operation unit 20 includes a display device 21 and an input device 22. The control apparatus 40 includes a CPU 201, a memory 203, a communication circuit 205, and an image processing unit 207.

The display device 21 is an example of the output device. The display device 21 together with the input device 22 may constitute a touch panel. The input device 22 may include one or more of input keys, a touch sensor, buttons, and switches, for example. Although not shown in FIG. 2, the operation unit 20 may further include a microphone and a speaker for inputting/outputting sound.

The central processing unit (CPU) 201 is a processor that controls overall operations of the inspection system 100. The CPU 201 may include a plurality of processors or CPU cores. Note that some or all of the functions described below in connection with the CPU 201 may be realized by a hardware circuit different from the CPU 201.

The memory 203 is a storage device that may include one or more of a read-only memory (ROM), a random access memory (RAM), a solid state drive (SSD), and a hard disk drive (HDD).

The communication circuit 205 is a circuit for the control apparatus 40 to communicate with another apparatus. The communication circuit 205 may include a network interface (I/F) for connection to a local area network (LAN). The CPU 201 communicates with the host computer 90 that is a type of information processing apparatus, via the communication circuit 205 and the LAN. In addition, the communication circuit 205 may include a connection I/F that intermediates connection between the control apparatus 40 and the operation unit 20, the image-forming apparatus 30, the inspection apparatus 50, the stacker 60, and the finisher 70.

The CPU 201 functions as a setting unit 211, a job control unit 213, and a notification unit 215 by executing a control program 221 that is loaded to the RAM.

The setting unit 211 manages settings related to image-forming and inspection in the inspection system 100 in cooperation with a below-described inspection setting unit 312 of the inspection controller 55. The setting unit 211 provides UIs for accepting settings that can be designated by the user via the operation unit 20. The UIs that are provided by the setting unit 211 include several setting screens to be described below in detail. The setting unit 211 causes the display device 21 to display a setting screen, and accepts user input via the input device 22. The setting unit 211 generates setting data 223 in accordance with the accepted user input, and causes the generated setting data 223 to be stored in the memory 203.

The job control unit 213 controls execution of a job in the inspection system 100. The job control unit 213 accepts a request to execute a print job, via the operation unit 20 or the communication circuit 205, for example. The job control unit 213 stores input image data 225 designated as a print target, in the memory 203. The image processing unit 207 performs, on the input image data 225, image processing such as rasterizing, conversion of the color space, conversion and binarization of the resolution. The image processing unit 207 may include a raster image processor (RIP) for interpreting page descriptive language (PDL) data into bitmap raster image data. Moreover, the job control unit 213 controls the image-forming apparatus 30 to form an image that is based on the input image data 225 processed by the image processing unit 207, on a sheet in accordance with the setting data 223.

When execution of a print job that is accompanied by inspection is requested, the job control unit 213 controls the inspection apparatus 50 to inspect an image formed on a sheet by the image-forming apparatus 30 (hereinafter, referred to as an “inspection target image”). The job control unit 213 transmits reference image data 325 indicating a reference image that serves as a reference for inspection, to the inspection controller 55, for example. Typically, the reference image data 325 may be bitmap RGB data corresponding to the input image data 225. In addition, the job control unit 213 transmits, to the inspection controller 55, inspection setting data 323 indicating inspection-related settings, out of the setting data 223. As will be described below in detail, the inspection controller 55 inspects the inspection target image using the reference image data 325 in accordance with the inspection setting data 323, and transmits the inspection result to the control apparatus 40. The job control unit 213 controls the stacker 60 to switch the discharge destination of the sheet based on the inspection result received from the inspection controller 55. As described above, a sheet for which a fault has been detected may be discharged to the purge tray 66 of the stacker 60, for example. On the other hand, a sheet for which no fault has been detected may be discharged to a tray (tray that is a discharge destination of normal sheets) different from the purge tray 66, for example.

When execution of a print job accompanied by post-processing is requested, the job control unit 213 controls the post-processing unit 75 of the finisher 70 to execute designated post-processing. The job control unit 213 may cause the post-processing unit 75 to execute one or more of binding processing, bookbinding processing, and trimming processing on a sheet bundle, for example.

The notification unit 215 notifies the user of a result of executing a print job and a result of inspecting an inspection target image, using the display device 21. The notification unit 215 may display, on the display device 21, a result such as “passed” (normal) or “failed” (faulty) for each of the sheets set as inspection targets, for example. In addition, regarding a sheet for which a fault has been detected, the notification unit 215 may display the cause of the fault and the detected position of the fault on the display device 21. Note that the notification unit 215 may notify the user of an inspection result using sound, or may transmit a message (for example, in a mail format) in which an inspection result is written, to the host computer 90.

### 3. Configuration Example of Inspection Controller

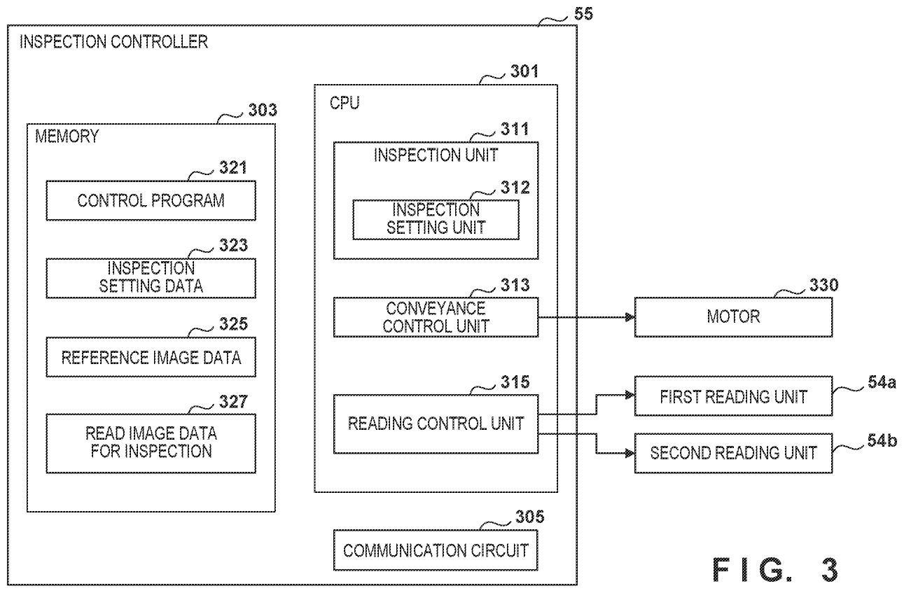

FIG. 3 is a block diagram showing an example of a detailed configuration of the inspection controller 55. Referring to FIG. 3, the inspection controller 55 includes a CPU 301, a memory 303, and a communication circuit 305.

The CPU 301 is a processor that controls overall operations of the inspection apparatus 50. The CPU 301 may include a plurality of processors or CPU cores. Note that some or all of the functions described below in connection with the CPU 301 may be realized by a hardware circuit different from the CPU 301.

The memory 303 is a storage device that may include one or more of a ROM, a RAM, an SSD, and an HDD. The communication circuit 305 is a circuit for the inspection apparatus 50 to communicate with another apparatus. The communication circuit 305 may include an connection I/F that intermediates connection between the inspection apparatus 50 and the operation unit 20, the image-forming apparatus 30, the control apparatus 40, the stacker 60, and the finisher 70.

The CPU 301 functions as an inspection unit 311, a conveyance control unit 313, and a reading control unit 315 by executing a control program 321 that is loaded to the RAM. The inspection unit 311 includes the inspection setting unit 312.

The inspection unit 311 receives, from the control apparatus 40, the inspection setting data 323 and the reference image data 325 along with a control signal instructing that inspection be executed. As described above, the reference image data 325 may be bitmap RGB data corresponding to the input image data 225, and represents a reference image that serves as a reference for inspection. The inspection unit 311 stores the inspection setting data 323 and the reference image data 325, in the memory 303. The inspection setting unit 312 adds settings required for executing inspection to the inspection setting data 323 by analyzing the reference image represented by the reference image data 325. The inspection unit 311 then starts to execute inspection.

The conveyance control unit 313 drives a motor 330 and rotates conveyance rollers 52 and 53 such that a sheet is conveyed along the conveyance path 51 at an appropriate timing, under control of the inspection unit 311.

The reading control unit 315 controls the first reading unit 54a to optically read an inspection target image on the lower side of a sheet at the timing when the sheet reaches the reading position of the first reading unit 54a. The reading control unit 315 obtains read image data generated by the first reading unit 54a as a reading result. In addition, when the two sides of a sheet are inspection targets, the reading control unit 315 controls the second reading unit 54b to optically read an inspection target image on the upper side of the sheet at the timing when the sheet reaches the reading position of the second reading unit 54b. The reading control unit 315 obtains read image data generated by the second reading unit 54b as a reading result. The reading control unit 315 stores the obtained read image data as read image data for inspection 327, in the memory 303. The read image data for inspection 327 represents an inspection target image of (each side of) each sheet that is an inspection target.

The inspection unit 311 inspects an inspection target image by comparing the reference image data 325 and the read image data for inspection 327 with each other. This inspection is also referred to as image inspection. The inspection unit 311 may determine whether or not the image data satisfies a defect condition that may include at least one of the following items, and determine that the inspection target image includes a defect (the inspection target image is faulty) if a defect condition is satisfied, for example.
the color difference between the inspection target image and the reference image exceeds a threshold
displacement between the inspection target image and the reference image exceeds a threshold
the inspection target image includes a smear or streak that is larger than a threshold
there is a difference in a result of optical character recognition (OCR) between the inspection target image and the reference image
   Note that these conditions may be combined in any manner. When image data satisfies no defect condition, the inspection unit 311 may determine that the inspection target image has no defect (the inspection target image is normal). The inspection unit 311 executes inspection in this manner on each inspection target image, and transmits an inspection result to the control apparatus 40.

### 4. Detailed Inspection-Related Setting

In the present embodiment, inspection-related settings at least include a non-inspection area. The inspection unit 311 excludes, from inspection, an image region set as a non-inspection area out of an inspection target image. For example, the inspection unit 311 does not perform comparison of image data of a non-inspection area, or does not determine that a sheet has failed inspection even if a defect is detected in a non-inspection area based on comparison.

In addition, the inspection-related settings may include an inspection level. In this case, the inspection unit 311 inspects an inspection target image at an inspection level that is set from among a plurality of candidates for inspection level (hereinafter, referred to as “candidate levels”). As the inspection level is higher (stricter), a smaller difference between the inspection target image and the reference image may result in detecting a defect. Assume that, for example, of an inspection level “A” and an inspection level “B”, the inspection level “A” is higher. In this case, a threshold (for example, a threshold for the above defect condition) that is used for inspection at the inspection level “A” is smaller than a threshold that is used for inspection at the inspection level “B”. In the following description, an inspection level is expressed as an integer number value, and a larger numerical value corresponds to a higher inspection level. An inspection level may be one of three candidate levels, namely levels 1 to 3, for example. An inspection level may be set in common for all of the regions other than a non-inspection area, or may be individually set for each specific sub-area.

As described above, the inspection setting unit 312 manages the inspection-related settings in cooperation with the setting unit 211 of the control apparatus 40. Some of the settings are accepted via a UI provided by the operation unit 20. However, when a non-inspection area is set depending only on user input, there is a risk that, when an area is not accurately designated, the usability or productivity will decrease, for example, a case arises where a sheet is determined as being faulty although there is no problem as a deliverable product.

In view of this, in the present embodiment, the inspection setting unit 312 detects predetermined marks in a reference image or an inspection target image, and sets an image region based on the detected positions of the predetermined marks to be a non-inspection area. The inspection setting unit 312 may detect the predetermined marks, for example, by executing pattern matching for searching for a pattern image of the predetermined marks, on the reference image data 325. The predetermined marks may be defined in common for a plurality of users or may be user-specific. In the latter case, the inspection setting unit 312 may accept registration of a pattern image of user-specific marks via a UI. Image data indicating the pattern image may be stored in the memory 303 in advance.

As an example, the predetermined marks may be trimming marks (also referred to as “trimming registry guides”) indicating trimming positions of a sheet. The trimming marks are disposed at positions offset from the four corners of a sheet by margins that are to be removed through trimming, for example. Since a portion of a sheet that is to be removed through trimming does not affect whether or not a final deliverable product is acceptable, it is possible to reduce errors in determination as to whether or not a deliverable product is acceptable, by excluding an image region outward of the trimming marks from inspection. That is to say, the inspection setting unit 312 determines that a region outward of the detected positions of trimming marks is an image region to be set as a non-inspection area. In print setting described below, when trimming processing is enabled, the post-processing unit 75 of the finisher 70 may automatically trim a sheet or a sheet bundle, at trimming positions corresponding to the detected positions of the trimming marks. As another example, trimming may be performed using a trimming machine that is separate from the inspection system 100, in place of being performed by the post-processing unit 75.

As described above, excluding an image region from inspection does not necessarily mean that inspection-related processing is not performed on the image region at all. The inspection unit 311 may determine whether or not the above defect condition is satisfied, by comparing the reference image data 325 with the read image data for inspection 327 with respect to a non-inspection area, and record the determination result in an inspection log, for example. In this case, a sheet for which a defect has been detected in an inspection target area is discharged as a faulty sheet to the purge tray 66, while a sheet for which a defect has been detected only in a non-inspection area may be discharged to a tray for normal sheets. The user or engineer can recognize that there was a potential defect in the non-inspection area, by viewing the inspection log.

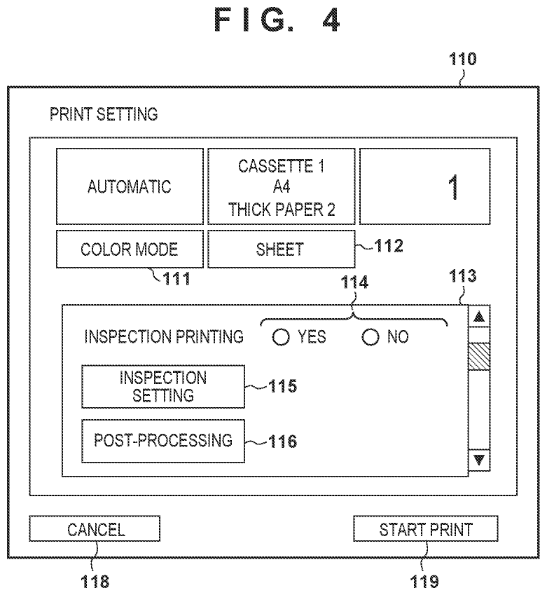

The setting unit 211 of the control apparatus 40 and the inspection setting unit 312 of the inspection controller 55 can provide various UIs for image-forming-related and inspection-related settings to the user. Three practical examples of UIs that are provided to the user and flow of related processing will be described below with reference to FIGS. 4 to 12.

### 4-1. First Practical Example

In a first practical example, the inspection setting unit 312 displays a preview that is based on reference image data, on the screen of the display. In addition, when user input instructing that a non-inspection area be set using predetermined marks is accepted, the inspection setting unit 312 sets an image region that is based on the detected positions of the predetermined marks, as a non-inspection area. The inspection setting unit 312 superimposes, on the preview of the reference image, an indication indicating an image region that is to be a non-inspection area determined based on the detected positions of the predetermined marks.

### (1) Print Setting Screen

FIG. 4 is an explanatory diagram showing an example of a configuration of a print setting screen according to the first practical example. A print setting screen 110 shown in FIG. 4 may be displayed on the display device 21 or the display of the host computer 90 when the user instructs the inspection system 100 to execute a print job, for example. The print setting screen 110 includes a first setting button 111, a second setting button 112, an advanced setting section 113, a cancel button 118, and a print start button 119. The advanced setting section 113 includes radio buttons 114, an inspection setting button 115, and a post-processing setting button 116.

The first setting button 111 is a button for designating a color mode (color or monochrome). The second setting button 112 is a button for designating a type of sheet to be used for printing. A paper feeding cassette 11 from which a sheet is fed may be switched in accordance with the type of sheet designated using the second setting button 112. The cancel button 118 is a button for cancelling execution of a print job and closing the print setting screen 110. The print start button 119 is a button for instructing execution of a print job.

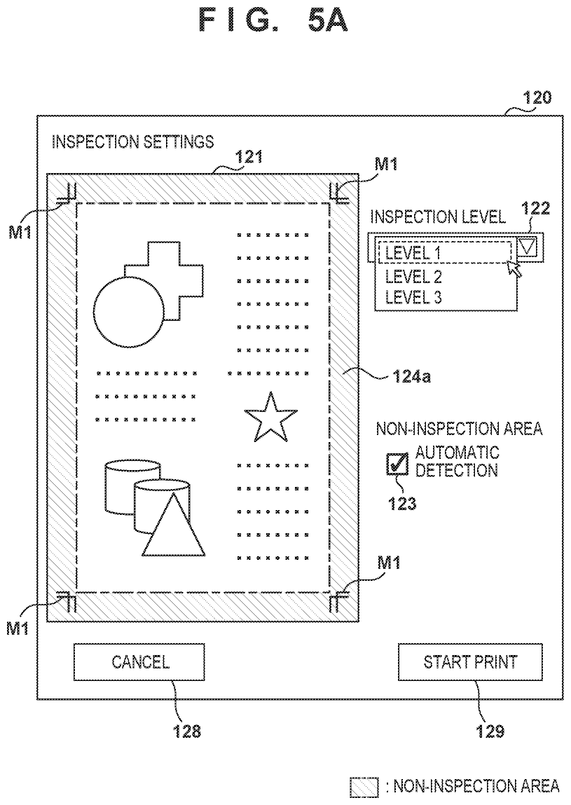

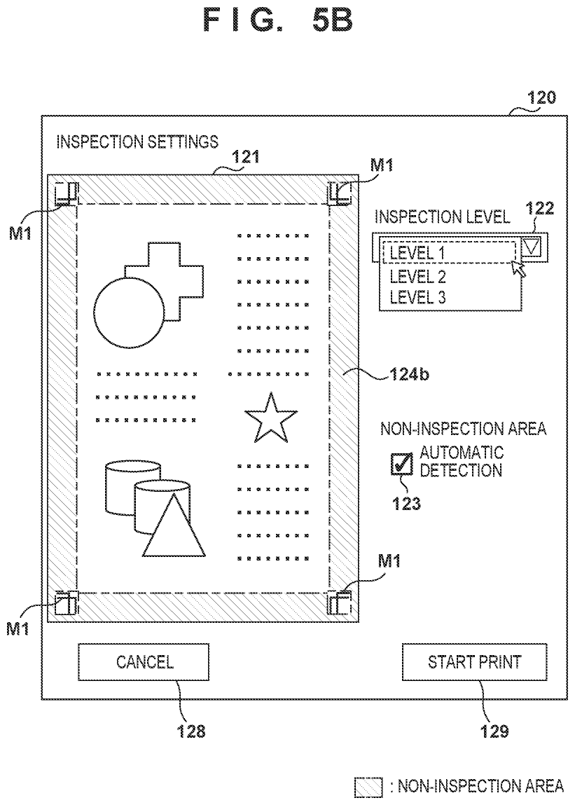

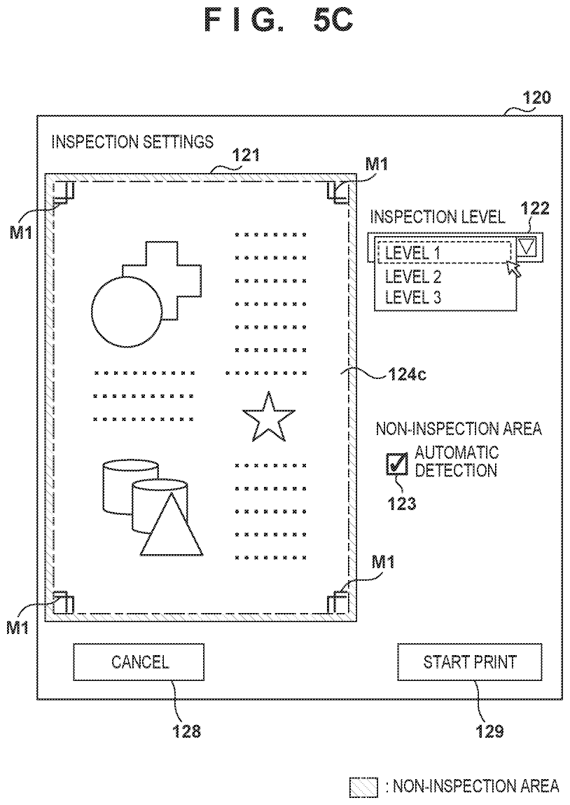

The radio buttons 114 in the advanced setting section 113 are objects for selecting whether or not to enable inspection of an image that is formed on a sheet in a print job. The inspection setting button 115 is a button for calling a setting screen for inspection-related settings. When the user performs an operation on the inspection setting button 115, the print setting screen 110 transitions to an inspection setting screen 120 shown in FIG. 5A. The post-processing setting button 116 is a button for calling a setting screen for settings of post-processing such as binding processing, bookbinding processing, and trimming processing.

### (2) Inspection Setting Screen

FIG. 5A is an explanatory diagram showing a first example of the configuration of the inspection setting screen according to the first practical example. Referring to FIG. 5A, the inspection setting screen 120 includes a preview section 121, a pulldown menu 122, a check box 123, a cancel button 128, and a print start button 129.

The preview section 121 is a section in which a preview of a reference image is displayed. The preview section 121 may be regarded as a preview screen related to image inspection. In the example in FIG. 5A, the reference image displayed in the preview section 121 includes four trimming marks M1. Here, the four trimming marks M1 each have a shape in which two L-shaped portions overlap each other, and the two L-shaped portions are rotated relative to adjacent L-shaped portions by 90°. The pulldown menu 122 is an object for the user to set a desired inspection level of image inspection from among a plurality of candidate levels. In the first practical example, an inspection level that is selected via the pulldown menu 122 may be applied in common to all of the image regions other than a non-inspection area. The check box 123 is an object for enabling automatic setting of a non-inspection area using predetermined marks (for example, trimming marks). In the example in FIG. 5A, the check box 123 is checked, and thus automatic setting of a non-inspection area is enabled. For this reason, in the preview section 121, an indication 124a indicates, with hatching, an image region determined based on the detected positions of the trimming marks M1, and is superimposed on the preview of a reference image (also referred to as a “main image”). The indication 124a is also referred to as an “additional image” considering that the indication 124a is added to the main image and is displayed in the preview section 121. In the example in FIG. 5A, the indication 124a indicates an outward region (second region) that occupies a portion outward of a region (first region) corresponding to a trimmed sheet. The first region is a rectangular region inward of the indication 124a. The user can grasp, on the screen, that the image region covered by this indication 124a is set as a non-inspection area and is excluded from image inspection. The inner boundary line of the indication 124a may substantially match cutting lines in subsequent trimming, for example.

It can be said that the check box 123 is an object for the user to perform setting on whether or not to exclude the second region from image inspection. If the check box 123 is checked, the inspection setting unit 312 accepts the user setting to exclude the second region from image inspection whereas, if the check box 123 is not checked, the inspection setting unit 312 accepts the user setting not to exclude the second region from image inspection. If the user setting to exclude the second region from image inspection is accepted via the check box 123, and trimming marks are detected in a reference image, then the inspection setting unit 312 may display, in the preview section 121, the indication 124a that indicates the non-inspection area that is automatically detected. When trimming marks are not detected in the reference image (or when trimming marks are not included in the image), the indication 124a may not be displayed in the preview section 121.

The cancel button 128 is an object for cancelling setting in the inspection setting screen 120 and returning to the print setting screen 110. The print start button 129 is an object for accepting user input instructing to start execution of a print job (start of formation of an image) accompanied by inspection.

FIG. 5B is an explanatory diagram showing a second example of the configuration of the inspection setting screen according to the first practical example. In the second example, similarly to the above first example, the inspection setting screen 120 includes a preview section 121, a pulldown menu 122, a check box 123, a cancel button 128, and a print start button 129. Note that, in the preview section 121 in the second example, an indication 124b is superimposed on the preview of a reference image (the indication 124b is added to a main image). The indication 124b is an additional image that indicates, with hatching, an image region that is determined based on the detected position of the trimming marks M1. Here, a region indicated by the indication 124b is an outward region that occupies a portion outward of a first region corresponding a trimmed sheet, but is a region that excludes small rectangular regions occupied by the trimming marks M1. That is to say, the regions occupied by the trimming marks M1 are included in an inspection target region together with a stipulated region. The user can grasp, on the screen, that the image region covered by this indication 124b is set as a non-inspection area and is excluded from image inspection, and the trimming marks M1 are to be inspected. If the check box 123 is checked, the indication 124b is displayed in the preview section 121, and indicates a non-inspection area. If the check box 123 is not checked, the preview of a main image may be displayed in the preview section 121 in a state where the indication 124b is not added.

FIG. 5C is an explanatory diagram showing a third example of the configuration of the inspection setting screen according to the first practical example. In the third example, similarly to the above first and second examples, the inspection setting screen 120 includes a preview section 121, a pulldown menu 122, a check box 123, a cancel button 128, and a print start button 129. Note that, in the preview section 121 in the third example, an indication 124c is superimposed on the preview of a reference image (the indication 124c is added to a main image). The indication 124c is an additional image that indicates, with hatching, an image region that is determined based on the detected positions of the trimming marks M1. Here, a region indicated by the indication 124c is an outward region that occupies a portion outward of the trimming marks M1. That is to say, regions occupied by the trimming marks M1 are included in an inspection target region together with a stipulated region. The user can grasp, on the screen, that the image region covered by this indication 124c is set as a non-inspection area, and is excluded from image inspection, and the trimming marks M1 are to be inspected. The indication 124c is displayed in the preview section 121 if the check box 123 is checked, and indicates a non-inspection area. If the check box 123 is not checked, the preview of the main image may be displayed in the preview section 121 in a state where the indication 124c is not added.

The trimming marks M1 shown in FIGS. 5A to 5C are marks that have a shape defined in advance and indicate trimming positions of a sheet. One of the two L-shaped portions of each trimming mark M1 indicates a trimming position, and the distance between the one L-shaped portion and the other L-shaped portion indicates a so-called bleed width. Specifically, with a focus on the main scanning direction (the left-right direction in the figure), the L-shaped portions offset to the right out of the L-shaped portions of the left trimming marks M1 and the L-shaped portions offset to the left out of the L-shaped portions of the right trimming marks M1 form a pair (a pair of L-shaped portions positioned on the inner side in the main scanning direction) that defines a trimming position in the main scanning direction. In addition, with a focus on the sub-scanning direction (the up-down direction in the figures), the L-shaped portions offset downward out of the L-shaped portions of the upper trimming marks M1 and the L-shaped portions offset upward out of the L-shaped portions of the lower trimming marks M1 form a pair (a pair of L-shaped portions positioned on the inner side in the sub-scanning direction) that defines a trimming position in the sub-scanning direction. In a case of inspecting whether or not these trimming positions are appropriately expressed, it may be sufficient that at least the portion of each of the trimming marks M1 used for defining the trimming position is included in an inspection target area, and the rest of the trimming mark M1 may be included in a non-inspection area.

That is, in an alteration of the first practical example, at least portions of the respective trimming marks M1 (for example, sides positioned on the inner side in the main scanning direction and the sub-scanning direction) are inspected in image inspection, and the rest of the respective trimming marks M1 other than the portions do not need to be inspected. In this alteration example, the indications 124b and 124c displayed in the preview section 121 may indicate a second region (for example, with hatching) in such a manner that the portions of the trimming marks M1 not to be inspected in image inspection are also included in the second region.

A region corresponding to the above bleed width is a spare region that is set with a predetermined width in the periphery of the first region. The bleed width is set in advance so as to prevent a blank space from being left at an edge of a trimmed sheet when there is a trimming error (displacement of a trimming position). That is, a main image may also be complementarily formed in the spare region corresponding to the bleed width. In another alteration example of the first practical example, a configuration may be adopted in which this spare region is also included in an inspection target area, and a region outward of the spare region is set as a non-inspection area. In this alteration example, the indications 124a and 124b that are displayed in the preview section 121 may indicate (for example, with hatching) a second region that is outward of the spare region and is not inspected in image inspection.

In all of the above examples, if it is determined that the main image is positioned outward of the first region, the non-inspection area may be set as a region excluding the main image. In this further alteration example, the indications 124a to 124c that are displayed in the preview section 121 may indicate (for example, with hatching) the second region, that is not inspected in image inspection, from which the main image is excluded.

### (3) Job Execution Processing

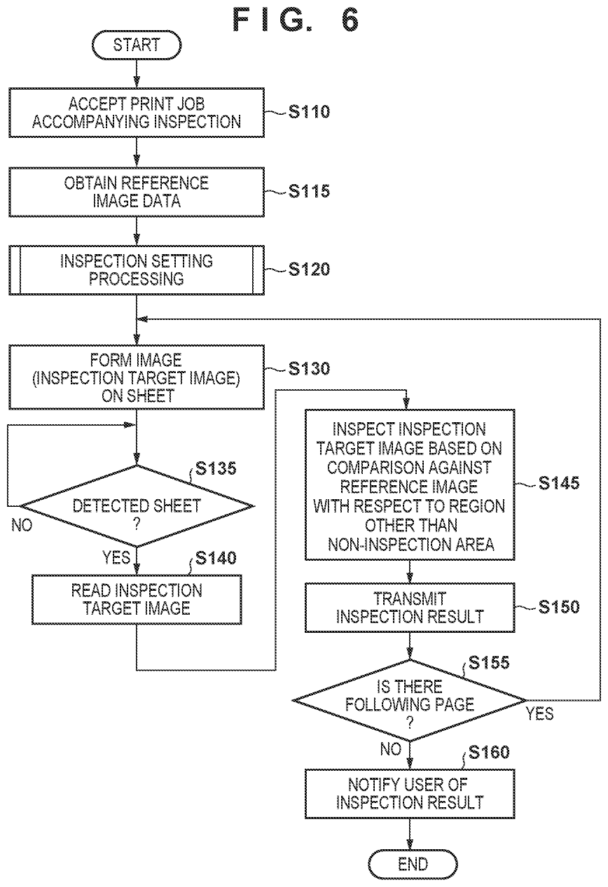

FIG. 6 is a flowchart showing an example of flow of job execution processing according to the first practical example. Note that, here, for ease of description, only one side of each sheet is set as an inspection target. In addition, in the following description, a processing step is abbreviated as S (step).

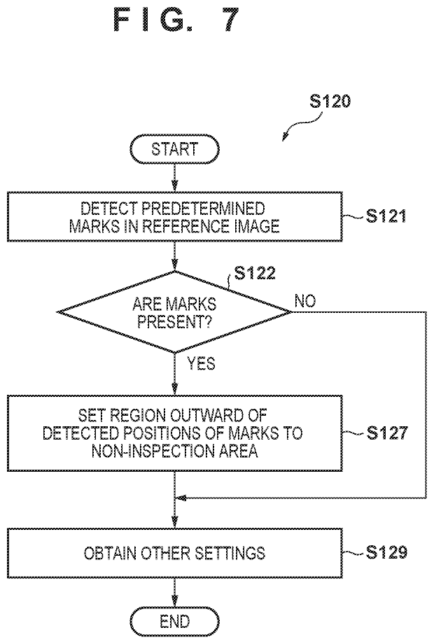

In S110, job execution processing in FIG. 6 is started in accordance with the control apparatus 40 accepting a print job accompanied by inspection. The setting unit 211 calls the inspection setting unit 312 of the inspection controller 55, for inspection-related settings. In S115, the inspection setting unit 312 obtains reference image data indicating a reference image of inspection. The inspection setting unit 312 may request the job control unit 213 to transmit reference image data, and receive reference image data that is provided from the job control unit 213 in response to the request, for example. Next, in S120, the inspection setting unit 312 executes inspection setting processing. Flow of inspection setting processing that is executed here will be described below in detail with reference to FIG. 7. The inspection setting unit 312 notifies the job control unit 213 that setting for inspection is completed. The job control unit 213 transmits input image data to the image-forming apparatus 30, and causes it to start an image-forming operation.

In S130, the image-forming apparatus 30 forms an image (inspection target image) on a sheet based on the input image data received from the control apparatus 40. In S135, the reading control unit 315 of the inspection apparatus 50 waits for the sheet on which the inspection target image is formed. When a sensor disposed on the conveyance path 51 detects the sheet, for example, the procedure advances to S140. In S140, the first reading unit 54a of the inspection apparatus 50 optically reads the inspection target image formed on the sheet that has reached the reading position, and generates read image data for inspection. Next, in S145, the inspection unit 311 inspects the inspection target image by comparing the inspection target image represented by the read image data for inspection with the reference image represented by the reference image data, with respect to a region other than a non-inspection area. In a case where a difference between the two images satisfies any of the above defect conditions, the inspection unit 311 determines that the inspection target image has a defect, for example. Meanwhile, in a case where there is no difference between the two images satisfying any defect condition, the inspection unit 311 determines that the inspection target image has no defect. Next, in S150, the inspection unit 311 transmits the inspection result to the job control unit 213. The job control unit 213 stores, in the memory 203, the inspection result received from the inspection unit 311. In addition, the job control unit 213 may control the stacker 60 to discharge a sheet for which a defect has been detected, to the purge tray 66. Next, in S155, the inspection unit 311 determines whether or not there is a following page to be processed in the job that is being executed. When there is a following page, the procedure returns to S130. If there is no following page, the procedure advances to S160.

In S160, the job control unit 213 controls the notification unit 215 to notify the user of the inspection result. The notification unit 215 may display the inspection result on a display, for example. In addition, the notification unit 215 may cause a speaker to output a sound message or special effects indicating the inspection result. In addition, the notification unit 215 may transmit a text message in which the inspection result is written, via a network. Note that, in a case where no defect was detected for any of the sheets, the notification unit 215 does not need to perform notification. Job execution processing in FIG. 6 then ends.

### (4) Inspection Setting Processing

FIG. 7 is a flowchart showing an example of detailed flow of inspection setting processing that may be executed by the inspection setting unit 312 in S120 in FIG. 6. Note that, here, assume that automatic setting of a non-inspection area using predetermined marks is enabled.

First, in S121, the inspection setting unit 312 attempts to detect predetermined marks in a reference image represented by reference image data.

The subsequent processing branches depending on whether or not predetermined marks are detected in the reference image in S122. If the predetermined marks are detected, the inspection setting unit 312 sets an image region outward of a first region corresponding to a trimmed sheet, as a non-inspection area, in S127. In this case, a preview in which an additional image indicating the non-inspection area is added may be provided in the preview section 121. If the predetermined marks are not detected in the reference image, S127 is skipped. In this case, in the preview section 121, a preview in which the additional image indicating the non-inspection area is not added may be provided. Cases where predetermined marks are not detected in a reference image may include a case where the reference image does not include the predetermined marks, and a case where the reference image includes the predetermined marks but detection of the predetermined marks fails. Next, in S129, the inspection setting unit 312 obtains other inspection-related settings such as an inspection level that is to be applied to the inspection target area. Inspection setting processing in FIG. 7 then ends.

### 4-2. Second Practical Example

In a second practical example, the inspection setting unit 312 requests, in response to predetermined marks having been detected in a reference image, a user's confirmation on setting the image region determined based on the detected positions as a non-inspection area. The inspection setting unit 312 then accepts user input instructing a non-inspection area be set, as a response to the request. If the user has no intention of setting a non-inspection area, the user may instruct that an image region that is based on the detected positions of the predetermined marks be not set as a non-inspection area. Also in the second practical example, similarly to the first practical example, the inspection setting unit 312 displays a preview that is based on reference image data, on the screen of the display. The inspection setting unit 312 may request the user to confirm whether or not to set a non-inspection area while superimposing indications indicating the detected positions of the predetermined marks on the preview of the reference image, for example.

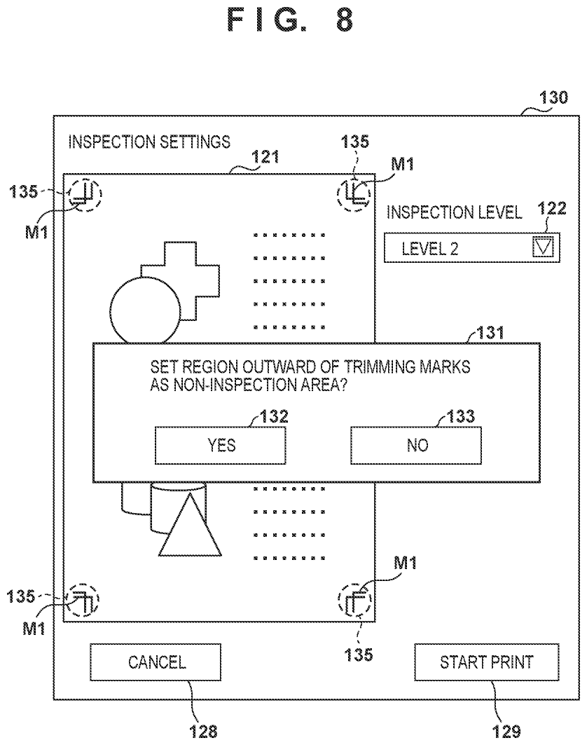

Also in the second practical example, the print setting screen 110 shown in FIG. 4 may be provided via the display device 21 or the display of the host computer 90, for basic settings of a print job. When the user performs an operation on the inspection setting button 115, the print setting screen 110 transitions to an inspection setting screen 130 shown in FIG. 8.

### (1) Inspection Setting Screen

Referring to FIG. 8, the inspection setting screen 130 has a configuration similar to that of the inspection setting screen 120 according to the first practical example, and includes a preview section 121, a pulldown menu 122, a cancel button 128, and a print start button 129. In addition, in the preview section 121, indications 135 indicating the detected positions of the trimming marks M1 in the reference image are superimposed on the reference image.

Furthermore, in the example in FIG. 8, a confirmation message 131, as an example, is superimposed on the inspection setting screen 130. The confirmation message 131 includes a text message requesting the user to confirm whether or not to set, as a non-inspection area, an image region determined based on the detected positions of the trimming marks M1, that is to say, a region outward of the four trimming marks M1. Upon checking that the trimming marks M1 have been properly detected by viewing the indications 135, for example, the user may perform an operation on a button 132 to instruct a non-inspection area to be set. Alternatively, when the trimming marks M1 have not been properly detected, or setting of a non-inspection area is not intended, the user may perform an operation on a button 133 to instruct not to set a non-inspection area.

Note that, in place of (or in addition to) the indications 135, the indication 124a, 124b, or 124c described with reference to FIGS. 5A to 5C may be displayed in the preview section 121 in order to indicate an image region that is a candidate for setting a non-inspection area. In addition, when the trimming marks M1 have not been properly detected, the inspection setting unit 312 may accept user input for adjusting the position and size of the non-inspection area, in the preview section 121.

### (2) Inspection Setting Processing

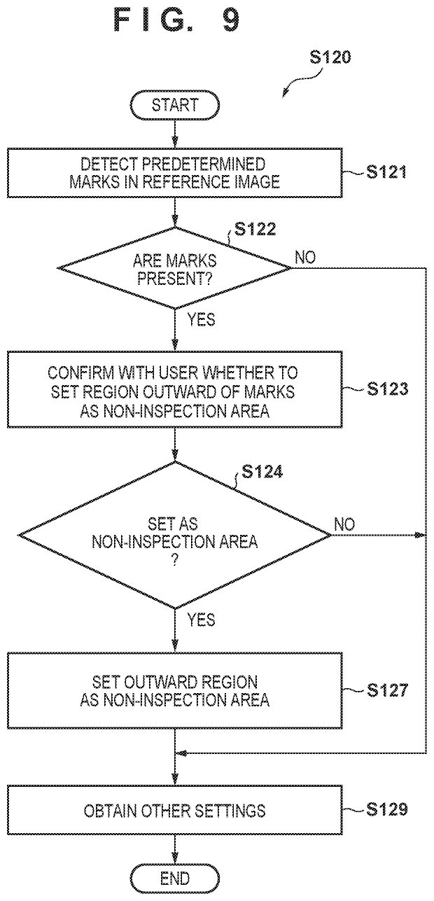

In the second practical example as well, a print job may be executed in flow that is similar to job execution processing described with reference to FIG. 6. However, when a print job accompanied by inspection is executed, the inspection setting unit 312 executes, in S120, inspection setting processing described with reference to FIG. 9.

FIG. 9 is a flowchart showing an example of detailed flow of inspection setting processing according to the second practical example. First, in S121, the inspection setting unit 312 attempts to detect predetermined marks in a reference image represented by reference image data. Subsequent processing branches depending on whether or not the predetermined marks are detected in the reference image in S122. If the predetermined marks are detected, the inspection setting unit 312 asks, in S123, the user whether or not to set a region outward of the detected positions of the predetermined marks as a non-inspection area. Subsequent processing branches, in S124, depending on whether or not user input instructing that a non-inspection area be set is accepted. When user input instructing that a non-inspection area be set is accepted, in S127, the inspection setting unit 312 sets the image region outward of the detected positions of the predetermined marks, as a non-inspection area. If no predetermined marks are detected in the reference image, or an instruction not to set a non-inspection area is given, S127 is skipped. Next, in S129, the inspection setting unit 312 obtains other inspection-related settings such as an inspection level to be applied to an inspection target area. Inspection setting processing in FIG. 9 then ends.

### 4-3. Third Practical Example

In a third practical example, the inspection setting unit 312 accepts, in addition to user input for confirmation regarding setting of a non-inspection area using predetermined marks, additional user input related to an exceptional region. The inspection setting unit 312 then sets another image region determined based on the additional user input, as an exceptional inspection target area or non-inspection area. As an example, the inspection setting unit 312 may set an image region determined based on the detected positions of predetermined marks (for example, a region outward of marks) as a non-inspection area, and then set a partial region of the non-inspection area as an exceptional inspection target area. As another example, when an instruction is given not to set, as a non-inspection area, an image region that is based on the detected positions of the predetermined marks, the inspection setting unit 312 may set another image region determined based on additional user input, as an exceptional non-inspection area.

Here, as a specific example, assume that a region in which so-called variable data is to be printed is set as an exceptional inspection target area. Variable printing refers to a print technique in which the content of a portion of an image to be formed on a plurality of sheets (for example, an address, a barcode, or a serial number) varies for each sheet. Print data for variable printing is written in personalized print markup language (PPML), for example, and may be made up of a master element and a variable element. The master element includes image data common to a plurality of sheets, and the variable element includes individual image data that differs for each sheet. When the reference image data 325 is written in PPML, the inspection setting unit 312 can recognize which partial region of the image is the region of the variable element (hereinafter, referred to as “variable region”).

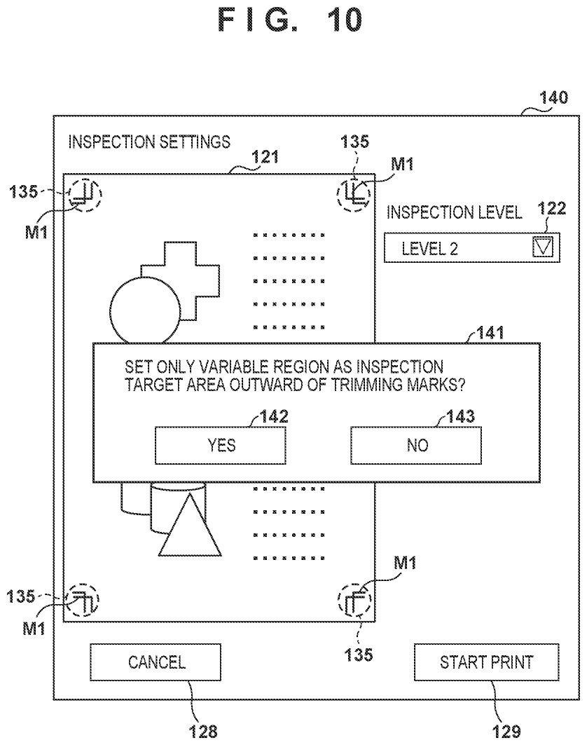

In the third practical example as well, for basic setting of a print job, the print setting screen 110 shown in FIG. 4 may be provided via the display device 21 or the display of the host computer 90. When the user performs an operation on the inspection setting button 115, the print setting screen 110 transitions to an inspection setting screen 140 shown in FIG. 10.

### (1) Inspection Setting Screen

Referring to FIG. 10, the inspection setting screen 140 has a configuration similar to that of the inspection setting screen 120 according to the first practical example, and includes a preview section 121, a pulldown menu 122, a cancel button 128, and print start button 129. In addition, in the preview section 121, the indications 135 indicating the detected positions of the trimming marks M1 in the reference image are superimposed on the reference image.

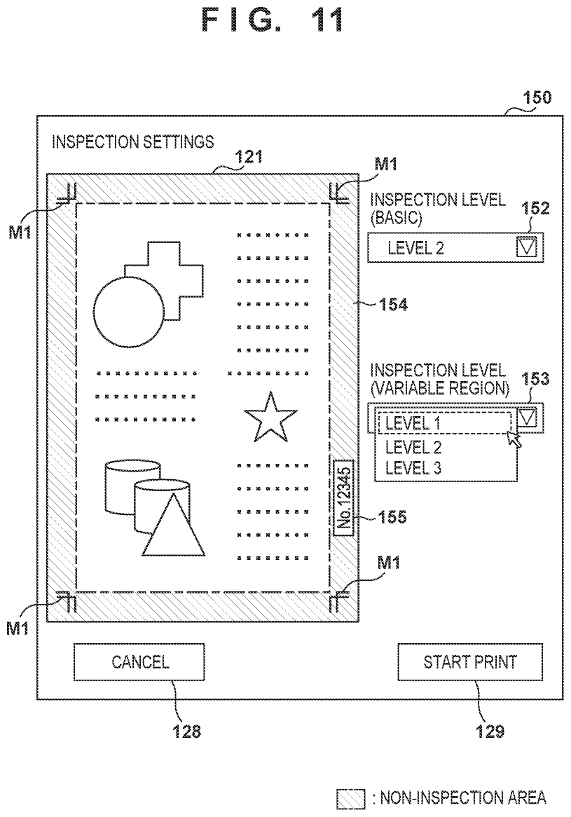

Furthermore, in the example in FIG. 10, a confirmation message 141, as an example, is superimposed on the inspection setting screen 140. The confirmation message 141 includes a text message requesting the user to confirm whether or not to set, as an inspection target area, only a variable region out of the region outward of the trimming marks M1. The user may perform an operation on a button 142 to instruct that the variable region be set as an exceptional inspection target area, or may perform an operation on a button 143 to instruct that such setting be not performed. When the user performs an operation on the button 142 to instruct that the variable region be set as an exceptional inspection target area, the inspection setting screen 140 transitions to the inspection setting screen 150 shown in FIG. 11.

Referring to FIG. 11, the inspection setting screen 150 includes the preview section 121, a pulldown menu 152, a pulldown menu 153, the cancel button 128, and the print start button 129. In addition, in the preview section 121, an indication 154 indicating an image region determined based on the detected positions of the trimming marks M1, and an indication 155 indicating a variable region are superimposed on the preview of the reference image. The variable region or another exceptional region may be automatically determined by the inspection setting unit 312, or may be designated by the user (for example, through a drag operation performed in the preview section 121). The indication 154 indicates an additional image representing a second region that occupies a region outward of a first region corresponding to a trimmed sheet. The first region is a rectangular region inward of the indication 154. The hatched image region indicated by the indication 154 is set as a non-inspection area, in which the variable region indicated by the indication 155 is set as an exceptional inspection target area.

The pulldown menu 152 is an object for the user to set an inspection level for a normal inspection target area (for example, an image region inward of the trimming marks M1) from among a plurality of candidate levels. The pulldown menu 153 is an object for the user to set an inspection level for an exceptional inspection target area (for example, a variable region) from among a plurality of candidate levels. A configuration may be adopted in which, in a case where a plurality of exceptional regions are inspection targets, a different inspection level can be selected for each exceptional region.

### (2) Inspection Setting Processing

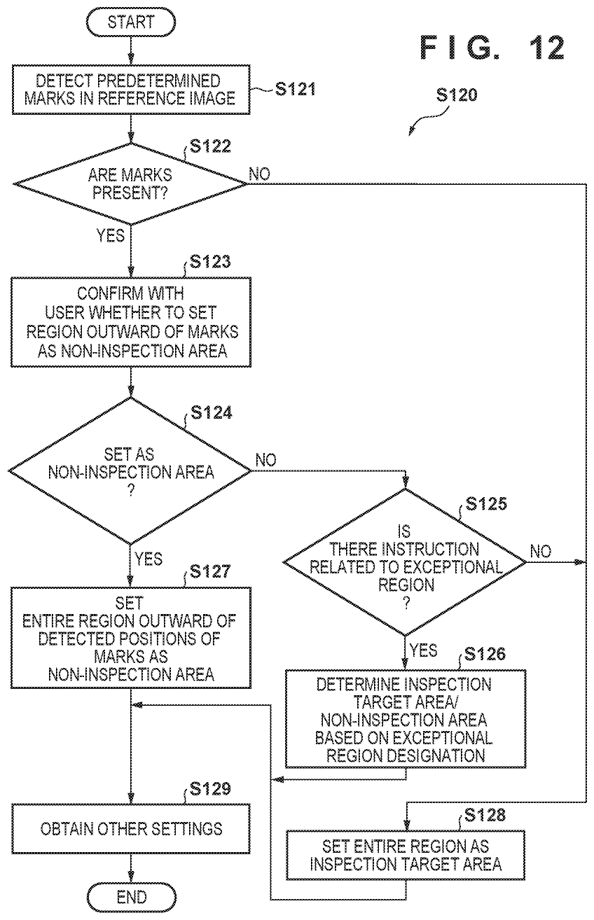

In the third practical example as well, a print job may be executed in flow similar to that of job execution processing described with reference to FIG. 6. However, when a print job accompanied by inspection is executed, the inspection setting unit 312 executes, in S120, inspection setting processing described with reference to FIG. 12.

FIG. 12 is a flowchart showing an example of detailed flow of inspection setting processing according to the third practical example. First, in S121, the inspection setting unit 312 attempts to detect predetermined marks in a reference image represented by reference image data. Subsequent processing branches depending on whether or not the predetermined marks are detected in the reference image in S122. If the predetermined marks are detected, the inspection setting unit 312 asks, in S123, the user whether or not to set, as a non-inspection area, a region outward of the detected positions of the predetermined marks. Subsequent processing branches, in S124, depending on whether or not user input instructing that a non-inspection area be set is accepted.

When user input instructing that a non-inspection area be not set is accepted, the inspection setting unit 312 accepts, in S125, additional user input related to an exceptional region. When an exceptional region is designated through additional user input, the inspection setting unit 312 determines, in S126, an inspection target area or a non-inspection area based on the designation of an exceptional region. When an instruction is given to set a variable region as an exceptional inspection target area, for example, the inspection setting unit 312 sets a margin region outward of the trimming marks as a non-inspection area, but sets only the variable region within the margin region as an exceptional inspection target area.

If user input instructing that a non-inspection area that is based on the detected positions of the predetermined marks be set is accepted in S124, the inspection setting unit 312 sets, in S127, the entire image region outward of the detected positions of predetermined marks as a non-inspection area.

If no predetermined marks were detected in S122, or if an exceptional region was not designated in S125, the inspection setting unit 312 sets, in S128, the entirety of the inspection target image as an inspection target area.

Next, in S129, the inspection setting unit 312 obtains other inspection-related settings such as an inspection level that is to be applied to a basic inspection target area and an inspection level that is to be applied to each exceptional inspection target area. Inspection setting processing in FIG. 12 then ends.

### 4-4. Alteration Examples

In an alteration example, the inspection setting unit 312 may accept user input for setting additional areas within an inspection target area that is not the non-inspection area based on the detected positions of predetermined mark (typically, a region inward of the detected positions of the predetermined marks). Here, examples of the additional areas include one or more of the following areas.
major inspection area for which an inspection level that is higher than those of other inspection target areas is set
simple inspection area for which an inspection level that is lower than those of other inspection target areas is set
individual setting area for which some inspection-related setting differs from those of other inspection target areas
   For these additional areas, an additional UI for the user to designate an individual inspection level or another setting item may be provided.

User input for setting an additional area may be a dragging or touching operation on the preview section 121 described with reference to FIGS. 5A to 5C, for example. The inspection setting unit 312 may limit user input such that a designated area does not overlap the non-inspection area when accepting such user input. Only when a designated area is completely included in an inner region that does not overlap the non-inspection area, the inspection setting unit 312 may accept user input as valid designation, for example. Accordingly, it is possible to efficiently perform complex area setting.

### 5. Conclusion

Thus far, various embodiments and practical examples of the technology according to the present disclosure have been described with reference to FIGS. 1 to 12. According to the above embodiments, in the inspection system for inspecting an inspection target image formed on a sheet by comparing a reference image data with read image data for inspection, an image region that is based on detected positions of predetermined marks within the image is set as a non-inspection area. Therefore, which image region is to be set as an inspection target or is to be excluded from inspection is kept from being inaccurately designated, whereby it is possible to appropriately exclude, from inspection, a region that does not affect whether or not a final deliverable product is acceptable, the yield of deliverable product is prevented from decreasing, and the usability and productivity improve.

In addition, in the above embodiments, when user input instructing that a non-inspection area be set using predetermined marks is accepted, an image region that is based on the detected positions of the predetermined marks may be set as a non-inspection area. That is to say, even if the image includes predetermined marks, the user can give an instruction on whether or not to exclude a corresponding image region from inspection. Therefore, the user can cause the system to perform appropriate inspection in accordance with his or her need. In addition, in the above embodiments, in response to predetermined marks having been detected, the user may be requested to confirm whether or not to set a corresponding image region as a non-inspection area. Therefore, when the image includes no predetermined marks, no confirmation is requested from the user, and thus it is possible to promptly execute a job while avoiding unnecessary interaction.

In addition, in the above embodiment, when a preview that is based on reference image data is displayed on the screen of the display device, a preview screen may be provided such that an additional image indicating a second region outward of a first region corresponding to a trimmed sheet is provided. For this reason, the user can easily identify which region corresponds to a trimmed sheet, and which region is to be removed through trimming. In addition, the user may be requested to confirm, on the screen, that the above second region is to be set as a non-inspection area. Therefore, the user can determine whether or not to set a non-inspection area while viewing the preview. An indication indicating an image region determined based on the detected positions of predetermined marks, or indications indicating the detected positions of predetermined marks may be superimposed on the above preview, for example. Therefore, when performing determination on whether or not to set a non-inspection area, the user can visually recognize, in an accurate manner, which portion of a reference image or an inspection target image will be excluded from inspection.

In addition, in the above embodiment, a region outward of the detected positions of predetermined marks may be determined as an image region that is to be set as a non-inspection area. Therefore, by providing predetermined marks to an image, a portion that does not affect whether or not a final deliverable product is acceptable, such as margin regions of a sheet or a region that is to be removed through trimming can be reliably excluded from inspection.

Note that, in the present specification, embodiments have been mainly described in which the CPU 301 of the inspection controller 55 functions as the inspection unit 311, but, in another embodiment, the CPU 201 of the control apparatus 40 or the processor of the host computer 90 may function as the inspection unit 311.

In addition, in the present specification, an example has been mainly described in which the inspection setting unit 312 receives reference image data from the job control unit 213. In a practical example, reference image data may be bitmap raster image data generated from input image data of a print job. In another practical example, reference image data may be read image data generated as a result of the inspection apparatus 50 or another reading apparatus optically reading a reference image formed on a sheet in advance (and may also be in the bitmap format). The reference image data may be generated by averaging results of reading a plurality of sheets on which the same reference image is formed. Expression “reference image data corresponding to input image data” does not limit the form and generation method of reference image data in any manner.

In addition, in the present specification, an example has been mainly described in which an indication indicating a non-inspection area is displayed in a preview section of an inspection setting screen, but a similar indication may be displayed on a result display screen for the user to view an inspection result, for example. With such a configuration, even when a user who has viewed a sheet discharged as a normal sheet visually recognizes dirt in an outer region of the sheet, since the visually recognized dirt is positioned in the non-inspection area, the user can easily understand that the sheet is a normal sheet by viewing indication on a result confirmation screen.

### 6. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-067375, filed on Apr. 17, 2023 and Japanese Patent Application No. 2024-054633, filed on Mar. 28, 2024 which are hereby incorporated by reference herein in their entirety.

What is claimed is:

1. An inspection system comprising:
an image-forming unit configured to form an image on a sheet;
a reading unit configured to read the image formed on the sheet; and
a controller configured to:
obtain reference image data for image inspection,
execute the image inspection on a result of reading the image by the reading unit, based on the obtained reference image data, and
control a display to display a preview screen related to the image inspection, the preview screen, in a case where the image includes a mark indicating a trimming position of the sheet, including:
a main image that includes the mark, and
an additional image that is added to the main image and indicates a second region outward of a first region corresponding to the sheet subjected to trimming.

2. The inspection system according to claim 1,
wherein the second region is not inspected in the image inspection.

3. The inspection system according to claim 1,
wherein the second region is a region that excludes the mark.

4. The inspection system according to claim 1,
wherein the second region is a region outward of the mark.

5. The inspection system according to claim 1,
wherein at least a portion of the mark is inspected in the image inspection.

6. The inspection system according to claim 5,
wherein a region of the mark other than the portion is not inspected in the image inspection.

7. The inspection system according to claim 1,
wherein the second region is a region outward of a spare region that is set with a predetermined width in a periphery of the first region.

8. The inspection system according to claim 7,
wherein the width of the spare region is set in advance so as to prevent a blank space from being left at an edge of the trimmed sheet.

9. The inspection system according to claim 1,
wherein the additional image indicates the second region with hatching, on the preview screen.

10. The inspection system according to claim 1,
wherein, in a case where the image does not include a mark indicating a trimming position of the sheet, the controller is configured to control the display to display a preview screen that is related to the image inspection and does not include the additional image.

11. The inspection system according to claim 1,
wherein, in a case where the mark is not detected in the image, the controller is configured to control the display to display a preview screen that is related to the image inspection and does not include the additional image.

12. The inspection system according to claim 1,
wherein, in a case where user setting for excluding the second region from the image inspection is accepted, the controller is configured to control the display to display the preview screen that includes the additional image.

13. The inspection system according to claim 12,
wherein the preview screen further includes an object for a user to perform setting on whether or not to exclude the second region from the image inspection.

14. The inspection system according to claim 13,
wherein, in a case where the user setting for excluding the second region from the image inspection is accepted via the object and the mark is detected in the image, the controller is configured to control the display to display the preview screen that includes the additional image.

15. The inspection system according to claim 1,
wherein the preview screen further includes an indication indicating a position of the mark.

16. The inspection system according to claim 1,
wherein, in a case where it is determined that the image is positioned outward of the first region, the second region is a region that excludes the image.

17. The inspection system according to claim 1,
wherein the preview screen further includes an object for accepting user input that instructs starting to form the image on the sheet.

18. The inspection system according to claim 1,
wherein the preview screen further includes an object for a user to set an inspection level of the image inspection.

19. The inspection system according to claim 1,
wherein the reading unit is configured to read the image on the sheet while conveying the sheet.

20. The inspection system according to claim 1,
wherein the reading unit is configured to read another sheet on which a reference image is formed to generate the reference image data, and
the controller is configured to obtain the reference image data generated by the reading unit.
